(19) United States
(12) Patent Application Publication
(10) Pub. No.: US 2015/0349605 A1
(43) Pub. Date: Dec. 3, 2015

(54) Actuator

(71) Applicant: Johnson Electric S.A., Murten (CH)

(72) Inventors: Yue LI, Hong Kong (CN); Jie CHAI, Shenzhen (CN); Kwong Yip POON, Hong Kong (CN); Wen Liang LI, Shenzhen (CN); Wai Chiu TANG, Hong Kong (CN); Bo YANG, Shenzhen (CN); Li Ping GUI, Shenzhen (CN)

(21) Appl. No.: 14/725,578

(22) Filed: May 29, 2015

(30) Foreign Application Priority Data
May 29, 2014 (CN) 201420282984.2

(51) Int. Cl. H02K 7/00; H02K 1/27

(52) U.S. Cl. CPC H02K 7/003; H02K 1/2786

(57) ABSTRACT

An actuator for controlling an air damper includes a motor, an output connector for connecting the actuator to the air damper, a transmission mechanism connecting the motor to the output connector, and an energy storage device that drives the output connector to close the air damper when power to the motor is cut off. The motor has a stator and a rotor. The stator has a stator core including a yoke and nine poles extending from the yoke. The rotor has a shaft and an annular permanent magnet. The magnet forms twelve poles with alternate N and S polarities. An inclination angle of boundaries between adjacent poles of the magnet relative to an axis of the motor is in the range of 13 to 17 degrees.

### CROSS REFERENCE TO RELATED APPLICATIONS

This non-provisional patent application claims priority under 35 U.S.C. § 119(a) from Utility Model Application No. 201420282984.2 filed in The People's Republic of China on May 29, 2014, the entire contents of which are hereby incorporated by reference.

### FIELD OF THE INVENTION

This invention relates to an electric motor for an actuator and in particular, to an actuator for controlling an air damper in a heating, ventilating, and air conditioning (HVAC) system.

### BACKGROUND OF THE INVENTION

Heating, ventilating, and air conditioning (HVAC) systems in buildings usually use an actuator to open or close an air damper. In normal situations, power is supplied to the actuator which retains the air damper in an opened position to ensure normal ventilation of the building. In case of emergency such as fire, the power supply to the actuator is cut off and the air damper must automatically move to a closed position to prevent fire or smoke spreading to an unaffected area.

A typical actuator includes a motor, a transmission mechanism and an energy storage device in the form of a spring. In normal situations, power is supplied to the motor which drives an output mechanism to open the air damper, causing the spring to be deformed. The motor retains the air damper in the open position overcoming a restoring force of the spring. In case of emergency, such as fire, the motor is turned off and the restoring force of the spring automatically moves the air damper to the closed position. When the power supply to the motor 14 is cut off, a detent torque of the motor, which is equal to a sum of the cogging torque and friction torque, is amplified by the transmission mechanism which resists movement of the air damper. The spring needs to overcome the detent torque of the motor to close the air damper. There exists one such type of motor used in the application above that has a detent torque of 0.6 mNm.

The higher the detent torque the greater the spring force required to drive the damper to the closed position. The greater the spring force, the greater the output power of the motor to drive the damper against the spring force and thus the more electricity used to open and keep open the damper.

### SUMMARY OF THE INVENTION

Hence, there is a desire for a motor with a reduced detent torque to allow for the use of a smaller spring and thus a potentially smaller motor.

Accordingly, in one aspect thereof, the present invention provides a motor for an actuator, comprising: a stator and a rotor, wherein the stator comprises a stator core and stator windings wound around the stator core, the stator core comprises a yoke and nine poles extending radially from the yoke, winding slots are formed between adjacent poles, the stator windings are wound around the poles and received in the winding slots, the rotor comprises a shaft and an annular permanent magnet fixed relative to the shaft, an air gap is formed between the magnet and the stator core, the magnet has twelve magnetic poles with alternate N and S polarities, and an inclination angle of boundaries between adjacent magnetic poles relative to an axis of the shaft is in the range of 13 to 17 degrees.

Preferably, the motor is a permanent magnet brushless motor, and the rotor surrounds the stator.

Preferably, a ratio of a width of the air gap to a thickness of the magnet is in the range of 0.49 to 0.51.

Preferably, a ratio of a thickness of the magnet to an inner radius of the rotor is in the range of 0.11 to 0.13.

Preferably, each pole comprises a pole body extending in a radial direction and a pole shoe extending in a circumferential direction of the motor from a distal end of the pole body, and a ratio of a width of the pole body in the circumferential direction of the motor to an outer radius of the stator core is in the range of 0.18 to 0.2.

Preferably, a ratio of a slot width of the winding slot to an outer radius of the stator core is in the range of 0.09 to 0.11.

According to a second aspect, the present invention provides an actuator comprising: a motor, an output connector for connecting the actuator to an external load, a transmission mechanism connecting the motor to the output connector, and an energy storage device arranged to drive the output connector to move the external load to a predetermined position by overcoming a detent torque of the motor when power to the motor is cut off, wherein the motor comprises a stator and a rotor, the stator comprises a stator core and stator windings wound around the stator core, the stator core comprises an yoke and nine poles extending radially from the yoke, winding slots are formed between adjacent poles, the stator windings are wound around the poles and received in the winding slots, the rotor comprises a shaft and an annular permanent magnet fixed relative to the shaft, an air gap is formed between the magnet and the stator core, the magnet has twelve magnetic poles with alternate N and S polarities, and an inclination angle of boundaries between adjacent magnetic poles relative to an axis of the shaft is in the range of 13 to 17 degrees.

Preferably, when power is supplied to the motor, the motor drives the output connector to retain the external load in a first position by overcoming a restoration force of the energy storage device; and when the power supply to the motor is cut off, the restoration force of the energy storage device drives the output connector to move the external load to a second position.

According to a third aspect, the present invention provides an actuator for controlling an air damper in a heating, ventilating, and air conditioning system, comprising: a motor, an output connector for connecting the actuator to the air damper, a transmission mechanism connected between the motor and the output connector, and an energy storage device arranged to drive the output connector to move the external load to a predetermined position by overcoming a detent torque of the motor when power to the motor is cut off, wherein the motor comprises a stator and a rotor, the stator comprises a stator core and stator windings wound around the stator core, the stator core comprises a yoke and nine poles extending radially from the yoke, winding slots are formed between adjacent poles, the stator windings are wound around the poles and received in the winding slots, the rotor comprises a shaft and an annular permanent magnet fixed relative to the shaft, an air gap is formed between the magnet and the stator core, the magnet has twelve magnetic poles with alternate N and S polarities, and an inclination angle of boundaries between adjacent magnetic poles relative to an axis of the shaft is in the range of 13 to 17 degrees.

Preferably, the energy storage device is a spring; the motor, when powered, drives the output connector to retain the air damper in an open position by overcoming a restoration force of the spring; and when the power supply to the motor is cut off, the restoration force of the spring drives the output connector to move the air damper to a closed position.

Preferably, the motor is a permanent magnet brushless motor, and the rotor surrounds the stator.

Preferably, a ratio of a width of the air gap to a thickness of the magnet is in the range of 0.49 to 0.51.

Preferably, a ratio of a thickness of the magnet to an inner radius of the rotor is in the range of 0.11 to 0.13.

Preferably, each pole comprises a pole body extending in a radial direction and a pole shoe extending in a circumferential direction of the motor from a distal end of the pole body, and a ratio of a width of the pole body in the circumferential direction of the motor to an outer radius of the stator core is in the range of 0.18 to 0.2.

Preferably, a ratio of a slot width of the winding slot to an outer radius of the stator core is in the range of 0.09 to 0.11.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a block diagram of an actuator for controlling an air damper in a heating, ventilating and air conditioning (HVAC) system;

FIG. 2 illustrates a motor of the actuator of FIG. 1;

FIG. 3 is an sectional view of the motor of FIG. 2;

FIG. 4 is a cross-sectional view of the motor of FIG. 2; and

FIG. 5 is a partial, development schematic of an annular permanent magnet of the motor of FIG. 2.

### DETAILED DESCRIPTION OF THE PREFERRED EMBODIMENTS

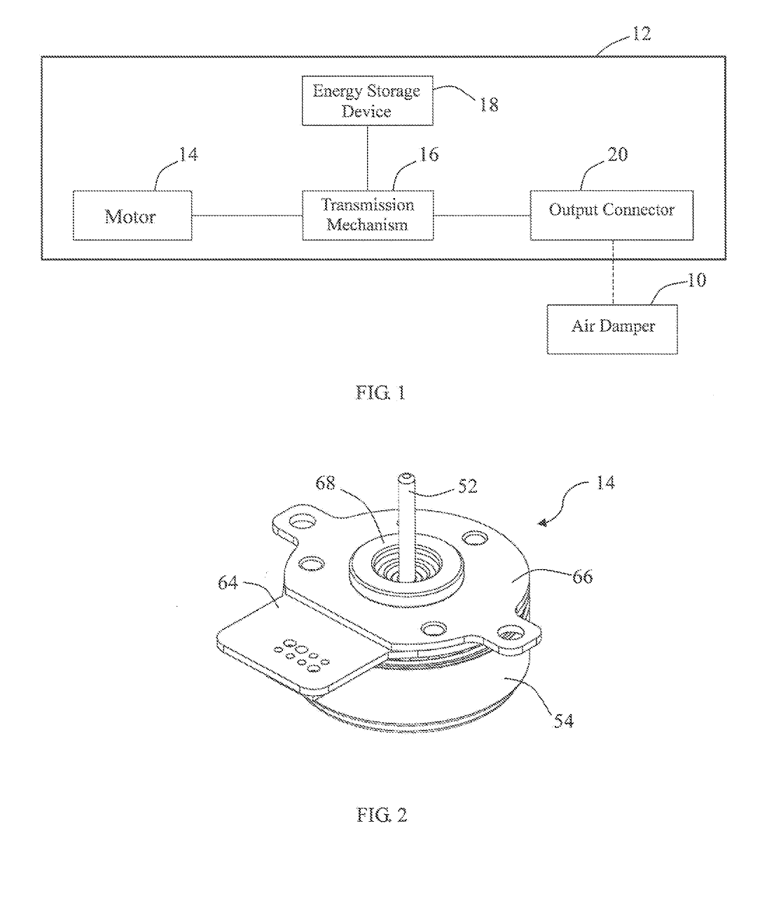

FIG. 1 illustrates an actuator 12 for controlling an air damper 10 (including a valve) in a heating, ventilating, and air conditioning (HVAC) system. The actuator 12 includes a motor 14, a transmission mechanism 16, an energy storage device 18, and an output connector 20. The transmission mechanism 16 connects the motor 14 to the output connector 20. Examples of transmission mechanisms include a gear transmission system or a belt transmission system. The transmission mechanism 16 can amplify an output torque of the motor 14 and transmit the amplified torque to the output connector 20. An example of an output connector may be a shaft coupler, which can be connected with a rotary shaft of the air damper 10 to move the air damper 10 between an open position and a closed position. Preferably, the energy storage device 18 is a spring connected with the transmission mechanism 16.

In normal conditions, power is supplied to the motor 14 such that the motor 14 generates a driving force to open the air damper and keep it open. In this case, the spring 18 is in a deformed state, and the motor 14 can retain the air damper 10 in the opened position by overcoming the restoring force of the spring 18. In an emergency, such as fire, the power supply to the motor 14 is cut off. As a result, the spring 18 restores back to its original state, driving the output connector 20 to close the air damper, overcoming the detent torque of the motor 14.

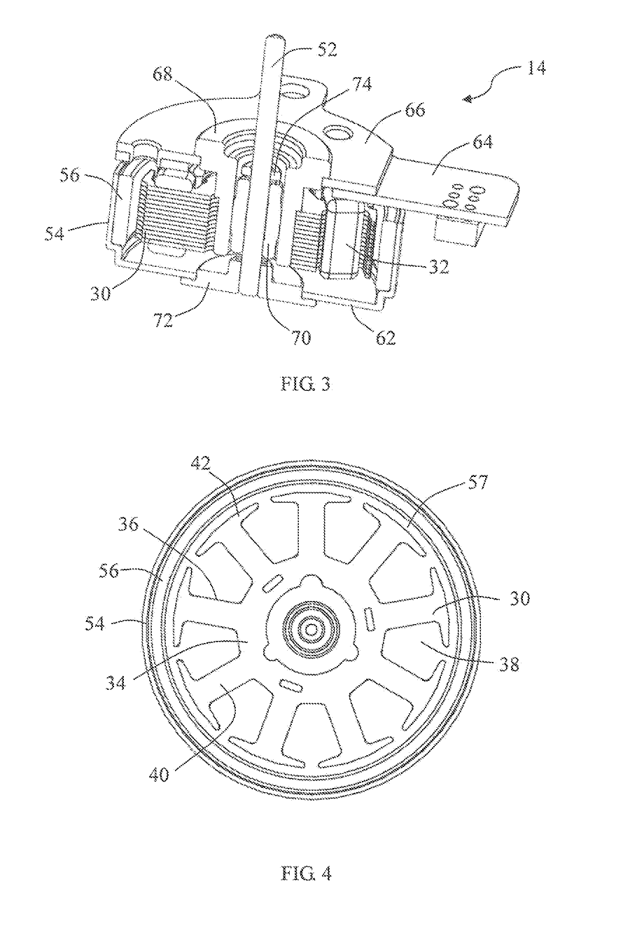

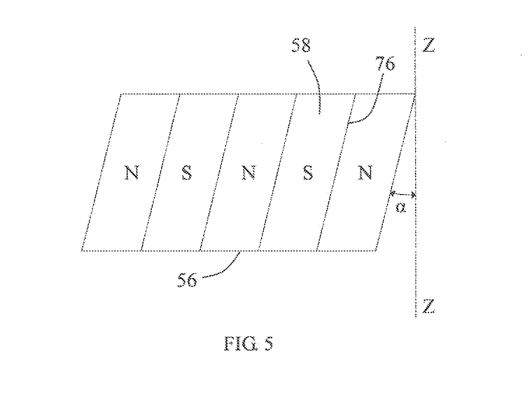

Referring to FIG. 2 through FIG. 5, the motor 14 includes a stator and a rotor rotatable relative to the stator. In this embodiment, the motor is a brushless, permanent magnet motor in which the rotor surrounds the stator to form an inner-stator and outer-rotor configuration.

The stator includes a stator core 30 made of magnetically conductive material (e.g. iron) and stator windings 32 wound around the stator core 30. The stator core 30 includes a yoke 34, preferably annular, and a plurality of stator poles 36 extending radially outwardly from the yoke 34. Winding slots 38 are formed between adjacent poles 36. The stator windings 32 are wound around the poles 36 and received in the winding slots 38. The stator core 30 may be formed by a plurality of core laminations stacked in an axial direction of the motor. Each pole 36 includes a pole body 40 extending in a radial direction (the meaning of the term “radial direction” used herein encompasses the strictly radial direction as well as other directions deviating less than 30 degrees from the strictly radial direction) of the motor, and a pole shoe 42 extending in a circumferential direction of the motor from a distal end of the pole body 40. The stator windings 32 are wound around the pole bodies 40. The stator windings 32 are powered by an external power supply to generate an exciting field with alternate N and S polarities.

The rotor includes a shaft 52, a barrel-shaped rotor housing 54 fixed to the shaft 52, and an annular permanent magnet 56 fixed to an inner surface of the housing 54. The housing 54 is made of magnetically conductive material. The magnet 56 confronts the stator core 30 across an air gap 57. In this embodiment, the magnet 56 forms a plurality of magnetic poles 58 with alternate N and S polarities. The housing 54 is cup-shaped which includes an open end and a closed end 62. The motor 14 further includes a circuit board 64 and an end cover 66. The circuit board 64 and the end cover 66 are disposed at the open end of the housing 54 and are spaced an axial distance from the open end of the housing 54.

The stator further includes a bearing seat 68 fixed to the yoke 34 and supporting a bearing 70. The shaft 52 of the rotor is rotatably mounted to the stator via the bearing seat 68 and bearing 70. The end cover 66 is fixed to the bearing seat 68. The circuit board 64 is fixed to an inner side of the end cover 66. A plurality of position sensors (e.g. Hall sensors) may be disposed on the circuit board to detect rotation of the rotor. One end of the shaft 52 is fixedly mounted to the housing 54 via a hub 72, and the other end of the shaft 52, as the output end, is coupled to the transmission mechanism. A recessed portion is formed in the bearing seat 68 for receiving a seal (not shown) to prevent contamination of the bearing. A retaining ring 74 is fixedly mounted to the shaft 52 and is received in the bearing seat and bears axially against an end of the bearing 70 to prevent the rotor separating from the stator.

In the embodiment described above, a twelve-pole nine-slot (twelve rotor poles and nine stator winding slots) outer-rotor brushless direct current motor is shown. An outer diameter of the motor (an outer diameter of the rotor housing 54) is 30 mm, an axial height of the motor (a distance between an outer end surface of the end cover 66 and an outer end surface of the housing closed end 62) is 15.6 mm, an axial height of the magnet is 8 mm, and an axial height of the stator core is 6.5 mm. Each magnetic pole 58 is radially polarized, and the boundaries 74 between adjacent magnetic poles 58 have an inclination angle a (FIG. 5) with respect to an axis Z-Z of the rotary shaft 52. Preferably, the inclination angle a is in the range of 13 to 17 degrees. A ratio of a width of the air gap 57 between the magnetic pole 56 and the stator core 30 to a thickness of the magnetic pole 56 is in the range of 0.49 to 0.51. A ratio of the thickness of the magnet 56 to an inner radius of the rotor (an inner radius of the magnet 56 in this embodiment) is in the range of 0.11 to 0.13. A ratio of a width of a pole body 40 of the pole of the stator core to an outer radius of the stator core 30 is in the range of 0.18 to 0.2. A ratio of a slot width (the distance between pole shoes of adjacent stator poles) to the outer radius of the stator core 30 is in the range of 0.09 to 0.11.

According to motor theory, as the harmonic order (the least common multiple of the number of the rotor magnetic poles and the number of the stator winding slots) of the motor increases, the cogging torque of the motor decreases. However, this inventor discovers through substantive tests that, if the motor size is the same, the twelve-pole nine-slot motor (with a harmonic order of 36) has a lower detent torque than that of a ten-pole nine-slot motor (with a harmonic order of 90) or a fourteen-pole twelve-slot motor (with a harmonic order of 84). When the inclination angle a of the boundaries of adjacent magnetic poles of the magnet with respect to the motor axis is set to be in the range of 13 to 17 degrees, the detent torque of the motor can be as low as 0.45 mNM, which represents a significant 25% reduction when compared with the typical data 0.6 mNm as known in the art.

It should be understood that the motor of the present invention may also be of an inner-rotor type, i.e. the rotor is located inside the stator, the rotor magnet is disposed on an outer surface of the rotor, the stator poles extend inwardly, and radial inward ends of the stator poles confront the rotor magnet.

It should also be understood that a rolling bearing, such as a ball bearing, roller bearing or needle bearing, may be used to support the shaft to reduce the friction , thus further reducing the detent torque of the motor.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A motor for an actuator, comprising: a stator and a rotor,
wherein the stator comprises a stator core and stator windings wound around the stator core,
the stator core comprises a yoke and nine poles extending radially from the yoke,
winding slots are formed between adjacent poles, the stator windings are wound around the poles and received in the winding slots,
the rotor comprises a shaft and an annular permanent magnet fixed relative to the shaft,
an air gap is formed between the magnet and the stator core,
the magnet has twelve magnetic poles with alternate N and S polarities, and an inclination angle of boundaries between adjacent magnetic poles relative to an axis of the shaft is in the range of 13 to 17 degrees.

2. The motor of claim 1, wherein the motor is a permanent magnet brushless motor, and the rotor surrounds the stator.

3. The motor of claim 2, wherein a ratio of a width of the air gap to a thickness of the magnet is in the range of 0.49 to 0.51.

4. The motor of claim 2, wherein a ratio of a thickness of the magnet to an inner radius of the rotor is in the range of 0.11 to 0.13.

5. The motor of claim 2, wherein each pole comprises a pole body extending in a radial direction and a pole shoe extending in a circumferential direction of the motor from a distal end of the pole body, and a ratio of a width of the pole body in the circumferential direction of the motor to an outer radius of the stator core is in the range of 0.18 to 0.2.

6. The motor of claim 2, wherein a ratio of a slot width of the winding slot to an outer radius of the stator core is in the range of 0.09 to 0.11.

7. An actuator comprising:
a motor,
an output connector for connecting the actuator to an external load,
a transmission mechanism connecting the motor to the output connector, and
an energy storage device arranged to drive the output connector to move the external load to a predetermined position by overcoming a detent torque of the motor when power to the motor is cut off,
wherein the motor comprises a stator and a rotor,
the stator comprises a stator core and stator windings wound around the stator core,
the stator core comprises an yoke and nine poles extending radially from the yoke,
winding slots are formed between adjacent poles, the stator windings are wound around the poles and received in the winding slots,
the rotor comprises a shaft and an annular permanent magnet fixed relative to the shaft,
an air gap is formed between the magnet and the stator core,
the magnet has twelve magnetic poles with alternate N and S polarities, and
an inclination angle of boundaries between adjacent magnetic poles relative to an axis of the shaft is in the range of 13 to 17 degrees.

8. The actuator of claim 7, wherein, when the power is supplied to the motor, the motor drives the output connector to retain the external load in a first position by overcoming a restoration force of the energy storage device; and
when the power supply to the motor is cut off, the restoration force of the energy storage device drives the output connector to move the external load to a second position.

9. The actuator of claim 7, wherein the motor is a permanent magnet brushless motor, and the rotor surrounds the stator.

10. The actuator of claim 9, wherein a ratio of a width of the air gap to a thickness of the magnet is in the range of 0.49 to 0.51.

11. The actuator of claim 9, wherein a ratio of a thickness of the magnet to an inner radius of the rotor is in the range of 0.11 to 0.13.

12. The actuator of claim 9, wherein each pole comprises a pole body extending in a radial direction and a pole shoe extending in a circumferential direction of the motor from a distal end of the pole body, and a ratio of a width of the pole body in the circumferential direction of the motor to an outer radius of the stator core is in the range of 0.18 to 0.2.

13. The actuator of claim 9, wherein a ratio of a slot width of the winding slot to an outer radius of the stator core is in the range of 0.09 to 0.11.

14. An actuator for controlling an air damper in a heating, ventilating, and air conditioning system, comprising:
a motor,
an output connector for connecting the actuator to the air damper,
a transmission mechanism connected between the motor and the output connector, and
an energy storage device arranged to drive the output connector to move the external load to a predetermined position by overcoming a detent torque of the motor when power to the motor is cut off,
wherein the motor comprises a stator and a rotor,
the stator comprises a stator core and stator windings wound around the stator core,
the stator core comprises a yoke and nine poles extending radially from the yoke, winding slots are formed between adjacent poles,
the stator windings are wound around the poles and received in the winding slots,
the rotor comprises a shaft and an annular permanent magnet fixed relative to the shaft,
an air gap is formed between the magnet and the stator core,
the magnet has twelve magnetic poles with alternate N and S polarities, and an inclination angle of boundaries between adjacent magnetic poles relative to an axis of the shaft is in the range of 13 to 17 degrees.

15. The actuator of claim 14, wherein the energy storage device is a spring; the motor, when powered, drives the output connector to retain the air damper in an open position by overcoming a restoration force of the spring; and when the power supply to the motor is cut off, the restoration force of the spring drives the output connector to move the air damper to a closed position.

16. The actuator of claim 14, wherein the motor is a permanent magnet brushless motor, and the rotor surrounds the stator.

17. The actuator of claim 16, wherein a ratio of a width of the air gap to a thickness of the magnet is in the range of 0.49 to 0.51.

18. The actuator of claim 16, wherein a ratio of a thickness of the magnet to an inner radius of the rotor is in the range of 0.11 to 0.13.

19. The actuator of claim 16, wherein each pole comprises a pole body extending in a radial direction and a pole shoe extending in a circumferential direction of the motor from a distal end of the pole body, and a ratio of a width of the pole body in the circumferential direction of the motor to an outer radius of the stator core is in the range of 0.18 to 0.2.

20. The actuator of claim 16, wherein a ratio of a slot width of the winding slot to an outer radius of the stator core is in the range of 0.09 to 0.11.
